(19) United States
(12) Patent Application Publication
(10) Pub. No.: US 2006/0279635 A1
(43) Pub. Date: Dec. 14, 2006

(54) Image forming apparatus to capture and print an image

(75) Inventor: Jun-won Jeong, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd.

(21) Appl. No.: 11/440,272

(22) Filed: May 25, 2006

(30) Foreign Application Priority Data
Jun. 11, 2005 (KR) 2005-0050088

(51) Int. Cl. H04N 5/225

(52) U.S. Cl. 348/207.2

(57) ABSTRACT

An image forming apparatus with an image forming unit to print the image information on a printing paper includes a display unit, a digital image capture unit to capture an image of an object and to obtain captured image information corresponding to the captured image, a selective input unit to select the captured image information displayed on the display unit, and a control unit to control the display unit to display the captured image information obtained by the digital image capture unit and to control the image forming unit to print the captured image information selected by the selective input unit.

### CROSS-REFERENCE TO RELATED APPLICATIONS

This application claims priority of Korean Patent Application No. 2005-0050088, filed on Jun. 11, 2005, in the Korean Intellectual Property Office, the entire contents of which are incorporated herein by reference.

### BACKGROUND OF THE INVENTION

1. Field of the Invention

The present general inventive concept relates to an image forming apparatus, and more particularly, to an image forming apparatus which can easily obtain a printed image of an object.

2. Description of the Related Art

In general, a digital image pickup (capture) device, such as a digital camera, a camera phone and a digital camcorder, picks up or takes images of an object and stores the images in the form of digital information. Compared with an optical and chemical image capture device using a conventional analog configuration, the digital image capture device has a simple structure, efficient duplication performance and excellent image editing performance, and thus has been widely used. Since the digital image capture device is compatible with a digital information processing device, such as a computer, image information obtained by capturing the object can be edited and transformed in a variety of different configurations, thus a demand for digital image capture devices is continuously increasing.

Although a user obtains the image information of the object through the digital image capture device, such image information is merely invisible digital information which can not be recognized by the human's eye. Accordingly, in order to confirm the image of the object, an additional device is required to visualize the image information stored in the digital image capture device. For example, the user can confirm the image information through a display device provided in the digital image capture device, or the user can input the image information to a personal computer to confirm the image on a monitor screen.

Also, the user can print the image information stored in the digital image capture device on a printing paper through a printer. Compared with a method of displaying the image information on the monitor screen, printing the image information on the printing paper is semi-permanent and makes it easier to keep the image information. Technology for photo and color printers continues to be developed, and so a printed image with high quality can be obtained.

However, in order to print the image of the object captured through the digital image capture device on the printing paper, the printer or the computer is required in addition to the digital image capture device. The user captures the image of the object using the digital image capture device and then stores the captured digital image information. The user then inputs the image information through the computer into the printer or directly from the digital image capture device to the printer to be printed. Accordingly, there is a burden when the captured image information is passed from the digital capture device through another device or when additional measures are required for capturing the image of the object and printing the captured image information on the printing paper.

### SUMMARY OF THE INVENTION

The present general inventive concept provides an image forming apparatus which can print an image of an object on a printing paper without passing the image through an additional device to obtain the printed image.

Additional aspects and advantages of the present general inventive concept will be set forth in part in the description which follows and, in part, will be obvious from the description, or may be learned by practice of the general inventive concept.

The foregoing and/or other aspects of the general inventive concept may be achieved by providing an image forming apparatus having an image forming unit to print image information on a printing paper, the image forming apparatus comprising a display unit, a digital image capture unit to capture an image of an object and to obtain image information corresponding to the captured image, a selective input unit to select the image information displayed on the display unit, and a control unit to control the display unit to display the image information obtained by the digital image capture unit and to control the image forming unit to print the image information selected by the selective input unit.

The image forming apparatus may further comprise a memory unit to store the image information obtained by the digital image capture unit, and the control unit may control the display unit to display the image information stored in the memory unit.

The image forming apparatus may further comprise a housing in which the display unit, the selective input unit, the memory unit and the control unit are located, and the digital image capture unit is detachably installed onto the housing such that the digital image capture unit may be attached or detached from the housing by a user.

The digital image capture unit can be connected to the housing by a flexible connecting member, and through which data is transmitted therebetween through the flexible connecting member.

The foregoing and/or other aspects of the general inventive concept may also be achieved by providing an image forming apparatus comprising a housing, an image forming unit disposed in the housing to print an image on a sheet of paper, a display unit disposed on the housing, a digital image capture unit connected to the housing to capture one or more images of an object, a selective input unit disposed on the housing to select at least one of the one or more images of the object, and a controller disposed in the housing to control the display unit to display the one or more images, and to control the image forming unit to print the at least one of the one or more images of the object selected by the selective input unit as the image on the sheet of paper.

The foregoing and/or other aspects of the general inventive concept may also be achieved by providing an image forming apparatus comprising a housing, an image forming unit having a print unit disposed within the housing to form an image on a sheet of paper, a display unit mounted on the housing, a digital image capture unit movably connected to the housing and electrically connected to the image forming unit and the display unit to capture one or more images of an object, a selective input unit disposed on the housing to select one of the one or more images of the object, and a controller disposed in the housing to control the display unit to display information on the one or more images, and to control the image forming unit to print the one of the one or more images displayed on the display unit.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating an image forming apparatus according to an embodiment of the present general inventive concept;

FIG. 2 is a perspective view illustrating the image forming apparatus of FIG. 1 according to an embodiment of the present general inventive concept; and

FIG. 3 is a perspective view illustrating the image forming apparatus of FIG. 1 according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

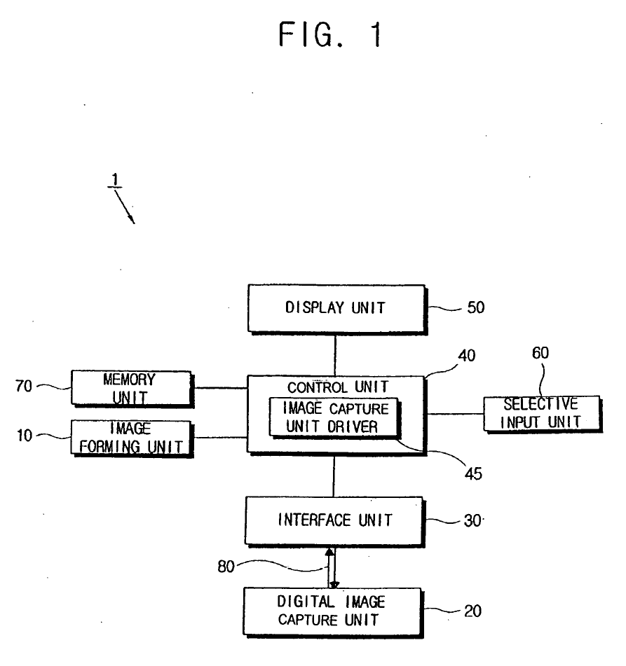

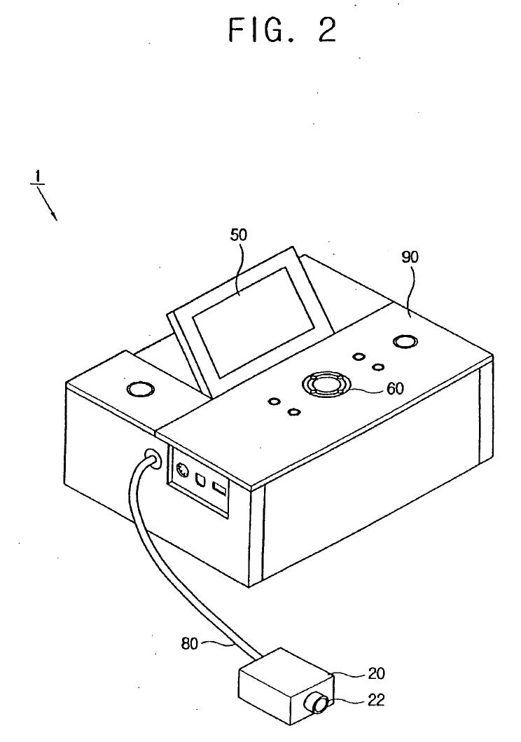

FIG. 1 is a block diagram illustrating an image forming apparatus 1 according to an embodiment of the present general inventive concept, and FIG. 2 is a perspective view illustrating the image forming apparatus 1 of FIG. 1. As illustrated in FIGS. 1 and 2, the image forming apparatus 1 is provided with an image forming unit 10 to print image information on a printing paper.

The image forming unit 10 may be a printer head provided with an ink jet head in which an ink nozzle is disposed and ejects ink on the printing paper to form an image, a developing device in which an electrostatic latent image is formed by exposing a photosensitive material to light, the electrostatic latent image is coated selectively with a developer and the developed electrostatic latent image is transferred to the printing paper to form the image, a thermal print head (TPH) in close contact with an ink ribbon that completely covers the printing paper so that the ink ribbon is heated selectively to form the image on the printing paper, or a conventional printing unit.

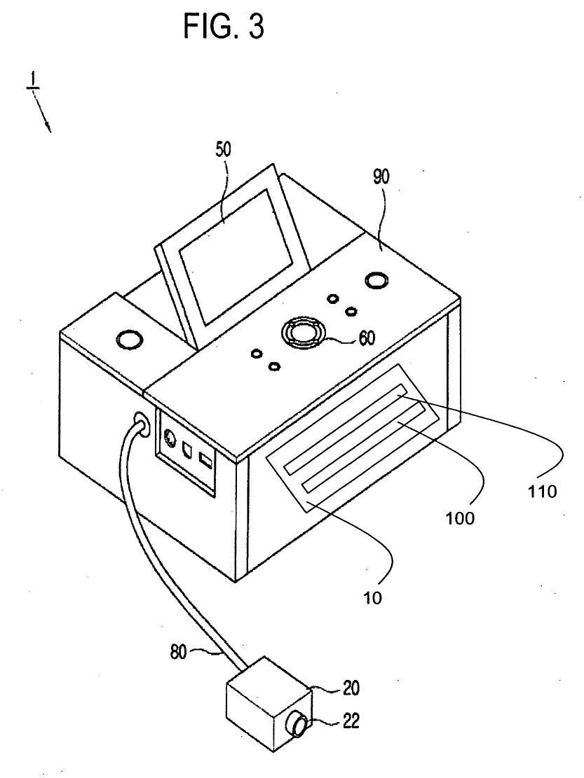

FIG. 3 illustrates the image forming apparatus 1 according to another embodiment of the general inventive concept. Referring to FIGS. 1-3, the image forming unit 10 of the image forming apparatus 1 may be provided with a paper feeding unit 100 and a paper discharging unit 110. The paper feeding unit 100 may store a certain amount of printing papers and may continuously feed the printing papers to the image forming unit 10. The paper discharging unit 110 receives the printing paper on which the image is formed and discharges the paper to an outside of the image forming apparatus 1. The paper discharging unit 110 may include a storage space to store a certain amount of the discharged printing papers. The paper feeding unit 100 and the paper discharging unit 110 are detachably installed onto the image forming apparatus 1, thus a size (volume) of the image forming apparatus 1 can be reduced.

As illustrated in FIG. 2, the image forming apparatus 1 has a display unit 50. The display unit 50 can display image information of an object obtained by a digital image pickup (capture) unit 20. The display unit 50 may be located on an upper surface of a housing 90 of the image forming apparatus 1, so a user can easily recognize the displayed image information. The display unit 50 can display operation states of the image forming apparatus 1 such as a printing mode, a standby mode, an error mode, e.g., a jamming mode and/or other error modes. Also, the display unit 50 can display information received through a selective input unit 60 and other prescribed input mediums, or information stored in a memory unit 70, as illustrated in FIG. 1. In a case that the image forming apparatus 1 is connected to a host computer (not shown), the display unit 50 can display information transmitted from the host computer.

The display unit 50 may be a monochrome or color display device, and may be, for example, a liquid crystal display (LCD) device, a plasma display panel (PDP) device, an organic electroluminescent (EL) display device or another conventional display device. The display unit 50 may also be a touch screen display device.

The image forming apparatus 1 is provided with the digital image capture unit 20. The digital image capture unit 20 picks up or captures the image of the object and obtains image information corresponding to the captured image of the object. The digital image capture unit 20 is provided with a lens 22. Once light reflected from the object is converged via the lens 22 on an image sensor (not shown), the converged light is converted into digitized image information through a predetermined analog-digital converting process. The image sensor may be, for example, a charge coupled device (CCD), a complementary metal oxide (CMOS) sensor or other conventional image sensor.

The digital image capture unit 20 captures the image of the object and converts the picked-up image into the image information using a prescribed processor. A digital image capture unit as described above is disclosed in Korean Patent Laid Open Publication No. 2004-82190 and Korean Patent application Nos. 2001-63992 and 2003-13197 which correspond to Korean Patent Laid Open Publication Nos. 2004-32288 and 2004-78317, respectively.

The image forming apparatus 1 is provided with the selective input unit 60. The selective input unit 60 can be used by a user to select one of the pieces of image information which is displayed on the display unit 50. The selective input unit 60 may be located on an exterior of the housing 90 to provide the user with easy access to the selective input unit 60. The selective input unit 60 may be provided with a predetermined input key pad (not shown) which can be operated the user. The selective input unit 60 may be a operating panel. Also, the selective input unit 60 may comprise a pointing device, such as a mouse to input location information or a keyboard to input a code. If the display unit 50 is a touch screen, the user can make a desired selection through the selective input unit 60 by touching a certain position on the display unit 50.

In a case that the display unit 50 displays the image information obtained by the digital image capture unit 60, the user can confirm the image information displayed on the display unit 50, and can select desired image information through the selective input unit 60 if the image information includes one or more captured images.

As illustrated in FIG. 1, a control unit 40 controls the display unit 50 to display the image information obtained by the digital image capture unit 20, and the image forming unit 10 to print the image information selected by the selective input unit 60. The control unit 40 may be provided with an image pickup (capture) unit driver 45 to drive the digital image capture unit 20. The control unit 40 can control the digital image capture unit 20 through the image capture unit driver 45 to capture the image of the object. An interface unit 30 may be connected between the control unit 40 and the digital image capture unit 20, thus a two-way communication may be performed between the control unit 40 and the digital image capture unit 20.

The control unit 40 controls the image forming unit 10 to print the image information selected by the selective input unit 60. The control unit 40 controls the transmission of the selected captured image information to the image forming unit 10, which may be, for example, the printer head, the developing device or the thermal print head (TPH), and controls a unit to feed the printing paper to the image forming unit 10. Once a process of forming the image in the image forming unit 10 is completed, the control unit 40 controls the image forming unit 10 to discharge the printing paper.

The image forming apparatus 1 is provided with the memory unit 70. The image information obtained by the digital image capture unit 20 is stored in the memory unit 70. Also, other information, for example, information on a drive of the image forming apparatus 1 can be stored in the memory unit 70.

The control unit 40 can control the display unit 50 to display the capture image information stored in the memory unit 70. A user can confirm the image information stored in the memory unit 70 on the display unit 50 and select specific image information through the selective input unit 60, so that the selected image information can be printed by the image forming unit 10.

The image forming apparatus 1 is provided with the housing 90 on which the display unit 50, and the selective input unit 60 are located, and an inside of which the memory unit 70 and the control unit 40 are located. The digital image capture unit 20 is detachably installed onto the housing 90.

The digital image capture unit 20 can be connected to the housing 90 by a flexible connecting member 80 through which data is transmitted. In a state that the digital image capture unit 20 is placed onto a certain location of the housing 90, the user may hold only the digital image capture unit 20 to adjust an orientation of the digital image capture unit 20 to be directed toward the object which is desired to be captured. To this end, the user, while confirming the display unit 50 fixed at a predetermined orientation, can easily capture an image of the desired object.

The image forming apparatus 1 may be a printer, a duplicator, a facsimile, a complexer, and the like. It is possible that the image forming apparatus 1 has a small size, a light weight and a compact shape to enable the user to easily handle the image forming apparatus 1. Also, it is possible that the image forming unit 10 is relatively light weight and small in size. As a result, the user, while carrying the image forming apparatus 1, captures the image of the desired object through the digital image capture unit 20, confirms immediately a state of the image on the display unit 50, and then selects the desirable image to instantly obtain a printed image.

In a case where the image forming apparatus 1 is portable, the digital image capture unit 20 can be placed directly onto the housing 90 without using the connecting member 80. It is possible to adjust an image capture direction of the digital image capture unit 20 with respect to the desired object by changing an orientation of the entire image forming apparatus 1. In such case, it is possible that the digital image capture unit 20 is coupled onto the housing 90 through a pivoting combination, a sliding combination or other configuration, so that a relative position of the digital image capture unit 20 can be changed and/or displaced with respect to the housing 90.

As described in the above description, the image forming apparatus 1 according to the present embodiment can print the captured image of the object on the printing paper without an additional printing device. To this end, the present general inventive concept captures the image of the object and directly prints the captured image onto the printing paper using the image forming apparatus 1. In this case, the captured image may not be stored in a memory and printed without requiring the host computer to process the image information. Also, the captured image of the object can be instantly printed on the printing paper, and thus the user can instantly confirm a state of the captured image of the object.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus having an image forming unit to print image information on a printing paper, comprising:
a display unit;
a digital image capture unit to capture an image of an object and to obtain image information corresponding to the captured image;
a selective input unit to select the image information displayed on the display unit; and
a control unit to control the display unit to display the image information obtained by the digital image capture unit and to control the image forming unit to print the image information selected by the selective input unit.

2. The image forming apparatus as set forth in claim 1, further comprising:
a memory unit to store the image information obtained by the digital image capture unit, and the control unit controls the display unit to display the image information stored in the memory unit.

3. The image forming apparatus as set forth in claim 2, further comprising:
a housing in which the display unit, the selective input unit, the memory unit and the control unit are located, and the digital image capture unit is detachably installed onto the housing such that the digital image capture unit may be attached or detached from the housing by a user.

4. The image forming apparatus as set forth in claim 3, further comprising:
a flexible connecting member to connect the digital image capture unit to the housing, and data is transmitted therebetween through the flexible connecting member.

5. The image forming apparatus as set forth in claim 1, further comprising:
a housing in which the display unit, the selective input unit, the memory unit and the control unit are located, wherein the digital image capture unit is detachably installed onto the housing.

6. The image forming apparatus as set forth in claim 5, further comprising:
a flexible connecting member to connect the digital image capture unit to the housing, and data is transmitted therebetween through the flexible connecting member.

7. An image forming apparatus comprising:
a housing;
an image forming unit disposed in the housing to print an image on a sheet of paper;
a display unit disposed on the housing;
a digital image capture unit connected to the housing to capture one or more images of an object;
a selective input unit disposed on the housing to select at least one of the one or more images of the object; and
a controller disposed in the housing to control the display unit to display the one or more images, and to control the image forming unit to print the at least one of the one or more images of the object selected by the selective input unit as the image on the sheet of paper.

8. The image forming apparatus of claim 7, wherein the digital image capture unit is connected to the controller through the housing.

9. The image forming apparatus of claim 7, wherein the digital image capture unit is movably connected to the housing to capture the one or more images of the object in different viewing angles.

10. The image forming apparatus of claim 7, wherein the digital image capture unit communicates with the controller to transmit the one or more images of the object to the display unit and the image forming unit.

11. The image forming apparatus of claim 7, wherein the display unit is disposed on an outer surface of the housing.

12. The image forming apparatus of claim 7, wherein the display unit comprises an end rotatably connected to the housing and a display window to display the one or more images of the object.

13. The image forming apparatus of claim 7, wherein the selective input unit is disposed on an outer surface of the housing and adjacent to the display unit.

14. The image forming apparatus of claim 7, wherein the image forming unit comprises a print unit disposed inside the housing to print the image.

15. The image forming apparatus of claim 14, wherein the image forming unit comprises a paper feeding unit detachably attached to the housing to supply the sheet of paper to the print unit.

16. The image forming apparatus of claim 14, wherein the image forming unit comprises a paper discharge unit detachably attached to the housing to discharge the printed sheet.

17. The image forming apparatus of claim 14, wherein the print unit comprises one of a print head, a developing unit, and a thermal print head.
